(19) United States
(12) Patent Application Publication
(10) Pub. No.: US 2011/0317835 A1
(43) Pub. Date: Dec. 29, 2011

(54) Method and Apparatus to Facilitate Wireline Transmission of an Encrypted Rolling Code

(76) Inventors: Edward T. Laird, Lombard, IL (US); James J. Fitzgibbon, Batavia, IL (US); Eric M. Gregori, Lindenhurst, IL (US)

(21) Appl. No.: 12/822,499

(22) Filed: Jun. 24, 2010

(51) Int. Cl. H04L 9/00

(52) U.S. Cl. 380/255

(57) ABSTRACT

An encrypted rolling code (11), a plurality of differing data bit order patterns (13), and a plurality of differing data inversion patterns 14) are provided. One then selects (15) a particular one of each of these patterns and uses those selected patterns as transmission characteristics when transmitting (16) at least part of the encrypted rolling code via a wireline connection.

### RELATED APPLICATION(S)

This application is related to co-pending and co-owned U.S. patent application entitled METHOD AND APPARATUS TO FACILITATE MESSAGE TRANSMISSION AND RECEPTION USING DIFFERENT TRANSMISSION CHARACTERISTICS, co-filed herewith and having attorney docket number 5569/97917, which is incorporated by reference in its entirety herein.

### TECHNICAL FIELD

This invention relates generally to the transmission of encrypted rolling codes.

### BACKGROUND

Rolling codes are known in the art. Rolling codes are often used, for example, in conjunction with movable barrier operators of various kinds (with movable barrier operators of various kinds also being known in the art and including operators that effect the selective control and movement of single panel and segmented garage doors, pivoting, rolling, and swinging gates, guard arms, rolling shutters, and various other movable barriers). In such an application setting, for example, a wireless transmitter can send a code to a corresponding movable barrier operator to cause the latter to effect a desired movement or other action with respect to, for example, a corresponding movable barrier. One such application setting is described in U.S. Publication No. 2007/0058811, filed Aug. 9, 2006, entitled METHOD AND APPARATUS TO FACILITATE TRANSMISSION OF AN ENCRYPTED ROLLING CODE, the contents of which are fully incorporated herein by reference.

When using rolling codes, the code transmitted by the wireless transmitter will change (often with each transmission) in accordance with a predetermined plan or algorithm that is also known to the movable barrier operator. Such an approach can foil the use of an intercepted code by an unauthorized party (using, for example, a so-called “code grabber”) because that intercepted code will not typically again, at least in the near term, be honored by that movable barrier operator should the unauthorized party attempt to themselves transmit that code. Without knowledge of the underlying scheme by which a next code is selected, the unauthorized party who gains access to a presently used code will still remain unable to leverage that knowledge in support of effecting unauthorized control over the movable barrier operator.

Such movable barrier operators also often respond to one or more other user interfaces that directly connect to the movable barrier operator via a wire (such as a pair of electrical conductors, a fiber optic cable, and so forth). These other user interfaces typically communicate with the movable barrier operator using an approach and/or protocol that is considerably simpler than the kinds of protocols that employ rolling codes as noted above. In some cases this may simply comprise monitoring the impedance states of the user interface. In other cases this may comprise relatively simple data transmissions conveying information regarding the user interface state(s). Typical movable barrier operators employ these kinds of approaches regardless of whether the movable barrier operator also employs a rolling-code based approach to protect the aforementioned wireless transmissions. This reflects, perhaps, the fact that wireline-based communications are already inherently better protected from the eavesdropping of code-grabbers and will not benefit from the use of a rolling code-based approach.

### BRIEF DESCRIPTION OF THE DRAWINGS

The above needs are at least partially met through provision of the method and apparatus to facilitate wireline transmission of an encrypted rolling code described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a depiction of prior art ternary encoding;

FIG. 4 comprises a flow diagram as configured in accordance with various embodiments of the invention;

FIG. 5 comprises a flow diagram as configured in accordance with various embodiments of the invention;

FIG. 6 comprises a mapping table as configured in accordance with various embodiments of the invention;

FIG. 7 comprises a schematic view of bit processing and parsing in accordance with various embodiments of the invention;

FIG. 8 comprises a comprises a schematic joint message diagram as configured in accordance with various embodiments of the invention;

FIG. 9 comprises a schematic view of bit selection and parsing as configured in accordance with various embodiments of the invention;

FIG. 10 comprises an illustrative example of a lookup table as configured in accordance with various embodiments of the invention;

FIG. 11 comprises a schematic view of message header information and two joint messages as configured in accordance with various embodiments of the invention;

FIG. 12 comprises a schematic view of bit parsing as configured in accordance with various embodiments of the invention;

FIG. 13 comprises a schematic view of a joint message as configured in accordance with various embodiments of the invention;

FIG. 14 comprises an illustrative example of a lookup table as configured in accordance with various embodiments of the invention;

FIG. 15 comprises a schematic view of bit processing and parsing as configured in accordance with various embodiments of the invention;

FIG. 16 comprises a schematic view of a joint message as configured in accordance with various embodiments of the invention;

FIG. 17 comprises an illustrative example of a lookup table as configured in accordance with various embodiments of the invention; and

FIG. 18 comprises a block diagram as configured in accordance with various embodiments of the invention.

FIG. 19 comprises an illustrative example of an application in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an encrypted rolling code, a plurality of differing data bit order patterns, and a plurality of differing data inversion patterns are provided. One selects a particular one of each of the bit order patterns and the data inversion patterns to provide selected patterns and then uses those selected patterns as transmission characteristics when transmitting via wireline or wireless methods at least part of the encrypted rolling code.

By these teachings, for example, a wireline remote control transmitter can be provided with data to be transmitted, where that data comprises, at least in part, at least portions of an encrypted rolling code and where that data comports with a particular data bit order pattern and a particular data inversion pattern as a function of a given portion of that rolling code. That data can then be transmitted in combination with the given portion of the encrypted rolling code wherein that given portion of the rolling code is not transmitted with any of its bits reordered or inverted as a function of the given portion itself. Accordingly, a wireline receiver that receives the data can then properly recover the re-ordered/inverted portions of the encrypted rolling code as a function of the given portion of the encrypted rolling code.

By one approach, if desired, the aforementioned data can comprise ternary data that is presented in a binary format. The use of ternary data can aid in facilitating compatible interaction with at least some movable barrier operators while also achieving an encryption effect at the same time as tending to ensure compatible use with binary peripheral platforms and the like. By one approach, this can comprise mapping each trit of the ternary data to a corresponding pair of binary bits. A pair of binary bits can represent 4 discrete information elements and by one approach, three of these discrete information elements can each correspond to one of the three trit states/levels while the fourth discrete information element (which otherwise comprises an illegal value) can serve a synchronization function.

If desired, in addition to the aforementioned encrypted rolling code, a fixed code can also be included in the transmission. By one approach, for example, both the aforementioned part of the encrypted rolling code and this fixed code can be transmitted using the above-described selected patterns as transmission characteristics.

The use of a rolling code-based approach in conjunction with wireline-based components is admittedly counterintuitive, given prior art practice in these regards. The applicant has determined, however, that such an approach can, in fact, prove advantageous in at least some application settings. As one example in these regards, the movable barrier operator now only needs a single and consistent approach to communicating with remote elements, regardless of whether those remote elements link to the movable barrier operator via wireless or wireline-based connections. This, in turn, can lead to reduced programming and design requirements, improved processing efficiencies, and corresponding cost reductions. As another example, such an approach can assist in assuring that an installer or end user does not inadvertently or intentionally connect a given movable barrier operator to a wireline remote component that may only be partially compatible with the operator and which might, over time, lead to inappropriate and unexpected behaviors on the part of the operator.

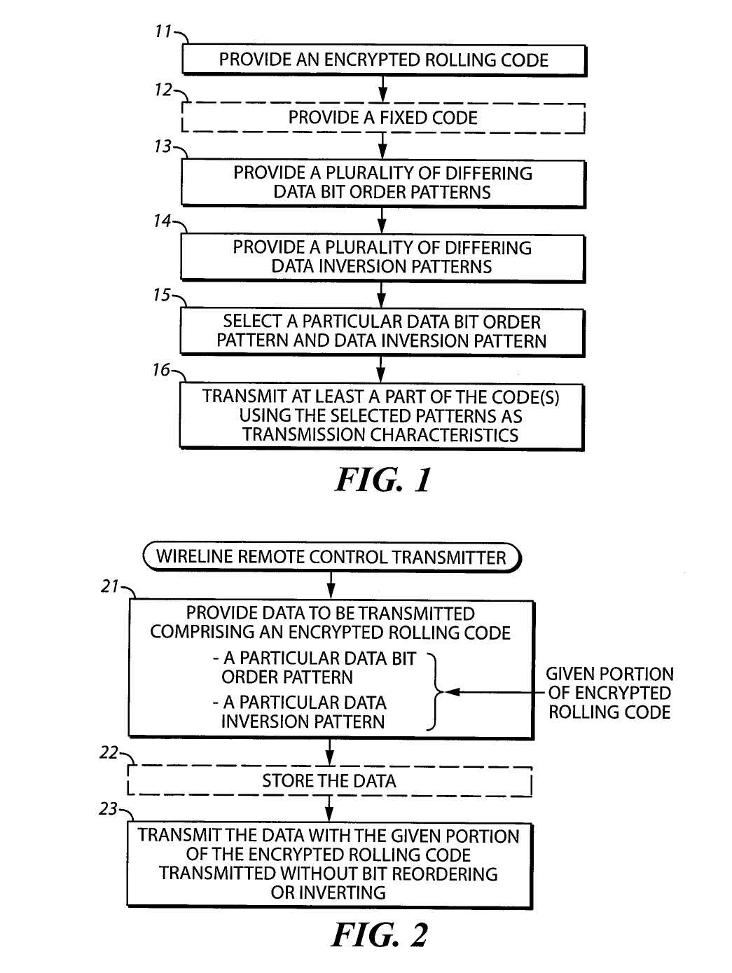

These and other benefits may become clearer upon making a thorough review and study of the following detailed description. Referring now to the drawings, and in particular to FIG. 1, an illustrative process in this regard provides 11 an encrypted rolling code. As will be illustrated in more detail below, this can comprise, if desired, providing an encrypted rolling code as a plurality of bit pairs as correspond to a ternary data set.

If desired, this process will also optionally accommodate providing 12 a fixed code. This fixed code can vary with the needs, requirements, and/or opportunities of a given application setting, but can, for example, comprise a value that is substantially unique to a given transmitter (be that transmitter a wireless platform or a wireline platform) and hence comprises a value that will serve to identify that given transmitter. Such an approach can be useful, for example, when used in conjunction with a remote control movable barrier operator transmitter (wireless or wireline).

This process also provides 13 a plurality of differing data bit order patterns. By one approach, for example, this can comprise data bit order patterns that each comprise a pattern for exactly three bits. As will be shown below, this can be particularly beneficial when used in conjunction with bit pairs that correlate to corresponding ternary data. Similarly, this process provides 14 a plurality of different data inversion patterns. As before, if desired, this can comprise providing patterns that each comprise a pattern for exactly three bits. The number of patterns provided in either case can vary as desired. By one approach, however, this can comprise providing at least nine different bit order patterns and nine different data inversion patterns. Illustrative examples in this regard are provided further herein.

This process then provides for selecting 15 a particular one of each of the data bit order patterns and the data inversion patterns to provide resultant corresponding selected patterns. There are various ways by which such selections can be made. By one approach, one may use a predetermined portion of the previously provided encrypted rolling code to inform the making of these selections. For example (and as will be illustrated in more detail herein), this can comprise using a predetermined four bit pairs of the encrypted rolling code as a basis for selecting the particular data bit order pattern and the particular data inversion pattern. As another example in this regard, in combination with the foregoing or in lieu thereof, this can comprise using a first predetermined portion of the encrypted rolling code to select a first particular data bit order pattern and a first data inversion pattern and using a second predetermined portion of the encrypted rolling code (that is, for example, discrete with respect to the first predetermined portion of the encrypted rolling code though this is not a fundamental requirement) to select a second particular data bit order pattern and a second data inversion pattern.

This process then provides for transmitting 16 at least a part of the encrypted rolling code itself (as well as at least a part of the above-described fixed code when present) using the aforementioned selected patterns as transmission characteristics. By one approach this can comprise making such a transmission using Manchester encoding as is known in the art. By one approach this can comprise making such a transmission via wireline.

So configured, these teachings are readily employed, for example, to facilitate the transmission of a wireline remote control message, including but not limited to a wireline transmission from a control unit (such as a wall control unit) immovably or semi-movably affixed (pursuant, for example, to a given installation procedure) to a surface of a fixed-in-place structure. This can comprise, for example, providing a fixed message having at least a first part and a second part along with an encrypted rolling code that has a first through a fourth part. The first part of the encrypted rolling code can then be used to select a particular data bit order pattern and a data inversion pattern to use as a set of first selected patterns while the second part of the encrypted rolling code can be used to select a second set of patterns from amongst the available candidate patterns. One can then transmit the first part of the fixed message and the third part of the encrypted rolling code using the first selected patterns as transmission characteristics while transmitting the second part of the fixed message and the fourth part of the encrypted rolling code using the second selected patterns as transmission characteristics.

The first selected patterns and the second selected patterns can comprise different selected patterns, or optionally, the same selected patterns. This can be due to the randomly differing contents of the first and second parts of the encrypted rolling code, but optionally, the first and second selected patterns can be intentionally selected to be different patterns or intentionally selected to be the same patterns.

By one approach, in this illustrative example this can also comprise transmitting the first and second parts of the encrypted rolling code without using either the first or selected patterns as transmission characteristics. So configured, the first and second parts of the encrypted rolling code are then readily usable as recovery identifiers that can be used by a receiver to recover the first and second parts of the fixed message and the third and fourth parts of the encrypted rolling code.

To illustrate further in this regard, these first and second parts of the encrypted rolling code could each comprise four bit pairs as correspond to the aforementioned ternary data. In such a case, two of the bit pairs as comprise the first part of the encrypted rolling code can be used with a lookup table to correlate those two bit pairs to a corresponding data bit order pattern. In a similar manner the remaining bit pairs can be used with a second lookup table (which may, if desired, actually comprise a part of the first lookup table) to correlate these bit pairs with a corresponding data inversion pattern. In a similar fashion, two of the bit pairs of the four bit pairs as comprise the second part of the encrypted rolling code can be used with that first lookup table to identify another data bit order pattern while the remaining two bit pairs can be used with the second lookup table to identify a corresponding data inversion pattern.

In such a case, the aforementioned transmission can then comprise transmitting the first part of the fixed message and the third part of the encrypted rolling code using the first selected patterns as transmission characteristics followed by transmitting the second part of the fixed message and the fourth part of the encrypted rolling code using the second selected patterns as transmission characteristics. In one example, there can exist a predetermined period of time during which no transmission is made following transmission of the first part of the fixed message and the third part of the encrypted rolling code using the first selected patterns as transmission characteristics before transmission of the second part of the fixed message and the fourth part of the encrypted rolling code The duration of this predetermined period of time can vary with the needs and opportunities of a given application setting. A duration of about 75 milliseconds may suffice for many expected purposes, but in a preferred example, the predetermined period of time is near zero or non-existent, thereby increasing network throughput.

In addition to facilitating a transmission of an encrypted rolling code and other content that comprises, for example, information that is unique to a given wireline transmitter (such as a unique identifier for that wireline transmitter), these teachings will further readily accommodate the transmission of additional data that is not substantially unique to the wireline transmitter. This can comprise, for example, providing a data payload (such as a wall control instruction such as OPEN, CLOSE, VACATION MODE, LIGHTS ON, LIGHTS OFF, and so forth) that is not substantially unique to a given wireline transmitter and then transmitting the first part of the fixed message, the third part of the encrypted rolling code, and a first part of this data payload while using the first selected patterns as transmission characteristics and transmitting the second part of the fixed message, the fourth part of the encrypted rolling code, and a second (remaining) portion of the data payload using the second selected patterns as transmission characteristics. When the data payload comprises a relatively large quantity of data as compared to the fixed message and/or the encrypted rolling code, additional portions of the data payload as are not accommodated by the just-described process can then be supplementally transmitted using one of the already selected patterns (or other patterns, if desired) as transmission characteristics.

As another specific illustrative example in this regard, and referring now to FIG. 2, a wireline remote control transmitter (such as a movable barrier operator wall control) can be configured and arranged to provide 21 data to be transmitted via wireline. This data can comprise, at least in part, at least portions of an encrypted rolling code. In any event, this data will comport with a particular data bit order pattern and a particular data inversion pattern as a function of a given portion of the rolling code. By one approach, if desired, this process can further comprise, at least in part, storing 22 this data in a memory prior to transmitting the data. The duration of such storage can vary considerably depending upon the specifics of a given application setting.

This wireline remote control transmitter can then transmit 23 this data in combination with the given portion of the encrypted rolling code such that the given portion of the encrypted rolling code is not transmitted with any of its bits reordered or inverted as a function of the given portion of the encrypted rolling code. So configured, a receiver that receives this data can properly recover the modified portions of the encrypted rolling code as a function, at least in part, of the unmodified given portion of the encrypted rolling code.

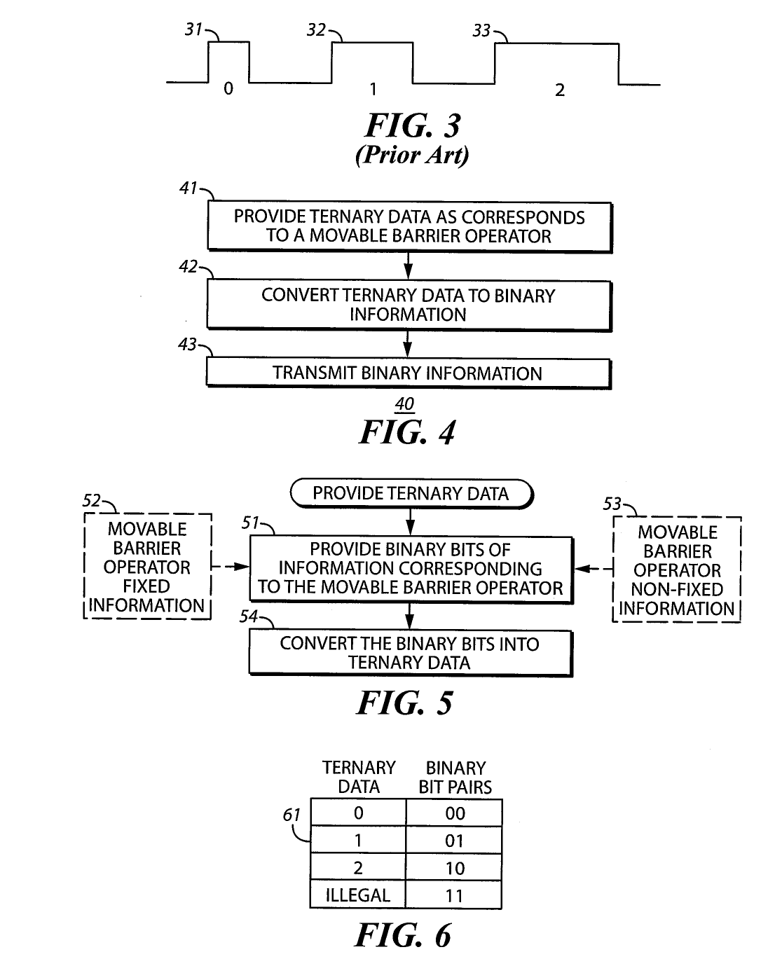

As noted above, these teachings are readily applied in a context that makes use of ternary data. It may therefore be helpful to first describe in more detail a typical ternary data protocol as one finds often deployed in conjunction with many movable barrier operators. Pursuant to one approach, pulses of similar amplitude have one of three different durations. For example, and referring now to FIG. 3, a first pulse 31, having a shortest duration, can represent the data element “0.” A second pulse 32, having a medium length duration, can represent the data element or state “1.” And a third pulse 33, having a longest duration, can represent the data element or state “2.” Such a data mapping protocol serves well to effect a base three-based data exchange. The present teachings can optionally accommodate use and leveraging of a ternary approach to effect relatively secure and compatible communications between a movable barrier operators and corresponding peripheral components of choice. These teachings are also compatible for use with an approach that eschews the specific ternary approach just described.

Referring now to FIG. 4, in general, these teachings will accommodate a process 40 that itself provides 41 ternary data as corresponds to a movable barrier operator and then converts 42 that ternary data to a binary format to provide resultant binary information. This binary information is then transmitted 43 from one platform to another. As will be shown below, this ternary-to-binary conversion process serves, at least in part, as a kind of encryption process which in turn aids in ensuring the authenticity and accuracy of the information being transmitted.

The ternary data itself can comprise, at least in part, bearer data. More particularly, and referring momentarily to FIG. 5, pursuant to one (optional) approach, provision of ternary data can comprise prior provision 51 of binary bits comprising information that corresponds to the movable barrier operator (for example, information sourced by, or intended for, a movable barrier operator). Such information can optionally comprise, for example, movable barrier operator fixed information 52 such as identifying information for a particular movable barrier operator, a particular peripheral component, or the like. Such information can also optionally comprise (in addition to or in lieu of fixed information 52) non-fixed information 53 such as the aforementioned data payload as again corresponds to the movable barrier operator. This non-fixed information 53 can comprise bearer data/information (such as, but not limited to, platform status information, commands, acknowledgments, the rolling code, data regarding the rolling code, and so forth). As already noted, this non-fixed information 53 can also comprise varying quantities of data if desired.

Optionally, these binary bits are then converted 54 into the aforementioned ternary data. This could comprise, in an appropriate platform, a conversion of the binary data into ternary data such as that described above with respect to FIG. 3. In general, such an approach need not be used. Instead, the binary data can be converted into a binary-bit-based ternary format (with an illustrative example being provided further below).

By one approach, however, this does not comprise a simple reversal of the binary-to-ternary process just described. Instead, the ternary-to-binary conversion step can comprise mapping each trit of the ternary data to a corresponding pair of binary bits. To illustrate such a map 61, and referring momentarily to FIG. 6, the ternary data element “0” (which corresponds to the usual binary data element “0”) maps to the binary pair “00.” In similar fashion, ternary “1” (which corresponds to usual binary “1”) maps to the binary pair “01” and ternary “2” (which corresponds to usual binary “11”) maps to the binary pair “01.”

This leaves an otherwise unused binary pair “11.” Pursuant to a preferred approach, this otherwise illegal value can serve a synchronization function when facilitating communications as between a movable barrier operator and one or more peripheral components when using a binary format that otherwise has no synchronization mechanism built into its format (for example, a stream of binary bits such as: 011011111110100111011101101111111010011101110110111111101001110111 which format lacks a frame marker or other point of synchronization). To illustrate, a synchronization signal/marker comprising this “11” binary pair can be used to indicate, for example, the regular end and/or start of a frame or message as in the following example: 110110111111011110111011110110111111101111110111111101101111111011111 where the bold font “11” regularly spaced binary pairs serve as frame markers (and which, due to their synchronized regular spacing, are readily distinguishable from other “11” pairs as may occur for whatever reason (illustratively depicted in the above example with italic font).

Those skilled in the art will appreciate that this process of converting binary information into ternary information, followed by conversion of that ternary information into corresponding binary pairs, yields, in most cases, a different bit sequence (and even a different number of bits) as compared to the initial binary information. This difference serves, at least in part, as a non-key-based encryption technique and hence provides a way of effecting the provision of an encrypted rolling code.

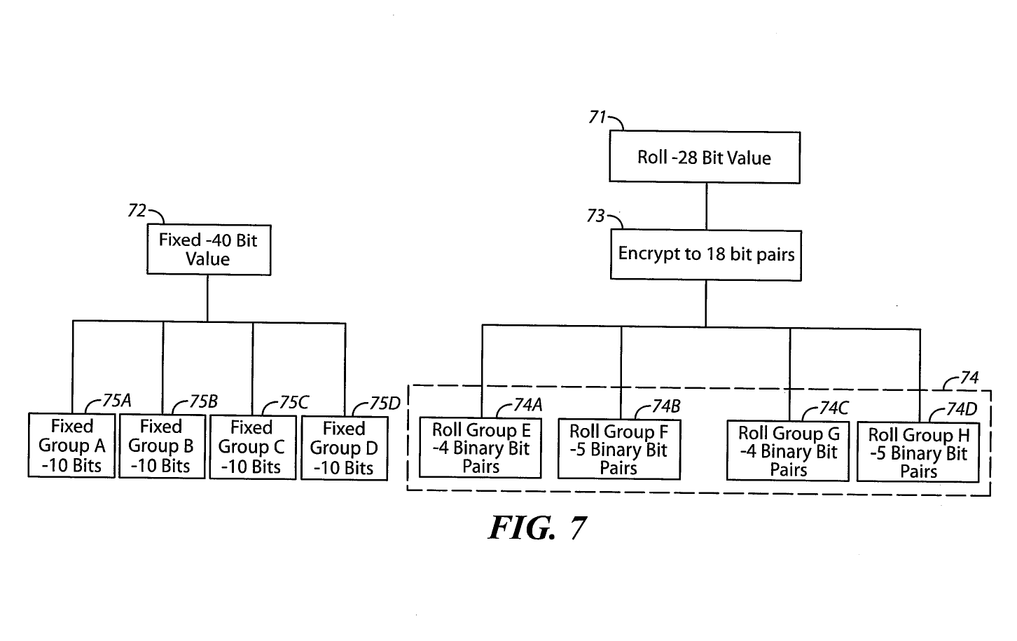

Referring now to FIG. 7, a more detailed illustrative embodiment will be presented. In this first illustrative example, the only substantive content to be associated and transmitted via wireline with a 28 bit rolling code 71 comprises a 40 bit value that represents fixed information 72. This fixed information 72 may serve, for example, to uniquely identify the wireline transmitter that will ultimately transmit this information as noted above.

In this particular illustrative embodiment, the bits comprising the rolling code 71 are encrypted 73 by mirroring the bits and then translating those mirrored bits into ternary values as suggested above to provide corresponding bit pairs (in this example, this would comprise 18 such bit pairs) to thereby provide a resultant encrypted rolling code 74. This mirroring can be applied to specific groupings of bits in the rolling code creating mirrored groups or can involve the entire value. In this illustrative example, the encrypted rolling code 74 is presented for further processing as four groups. In this example, these four groups comprise a roll group E 74A comprised of four binary bit pairs, a roll group F 74B comprised of five binary bit pairs, a roll group G 74C comprised of four binary bit pairs, and a roll group H 74D comprised of five binary bit pairs.

The 40 bit fixed information 72 is subdivided in a similar manner albeit sans encryption. This comprises, in this particular illustrative approach, forming four subgroups comprising a fixed group A 75A, a fixed group B 75B, a fixed group C 75C, and a fixed group D 75D, wherein each such group is comprised of 10 bits of the original 40 bit value.

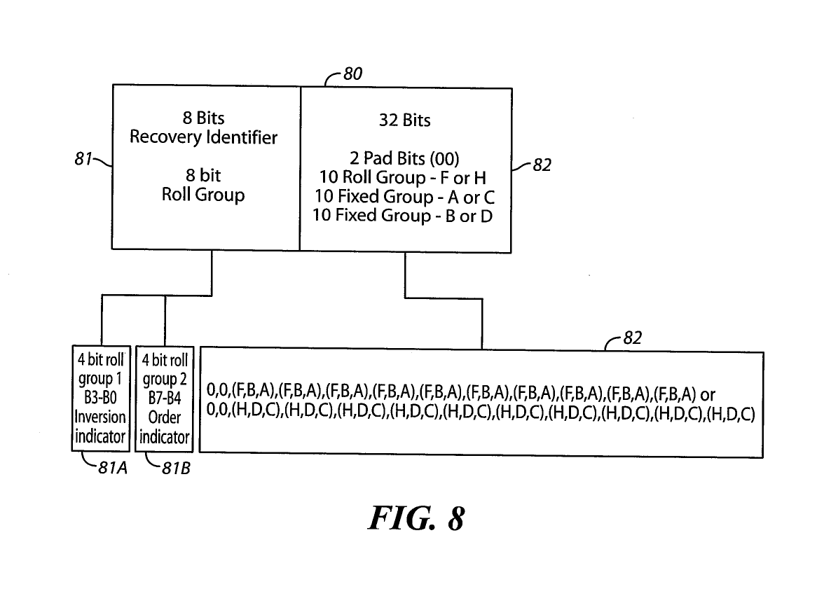

These variously partitioned data groups can then be used as shown in FIG. 8 to effect a desired wireline transmission. In this example, one or more joint messages 80 provide a primary vehicle by which to communicate the desired information (which includes both the encrypted rolling code and fixed information data as modified as a function of a given portion of the encrypted rolling code along with a recovery identifier that represents that given portion of the encrypted rolling code). This joint message 80 comprises, generally speaking, a first 8 bit portion 81 and a second 32 bit portion 82.

The first portion 81 comprises, in this embodiment, the following fields:

“B3, B2, B1, B0”—these two bit pairs 81A comprise an inversion pattern recovery identifier and are selected from the bits that comprise the encrypted rolling code 74 described above;

“B7, B6, B5, B4”—these two bit pairs 81B comprise a bit order pattern recovery identifier and are also selected from the bits that comprise the encrypted rolling code 74 described above.

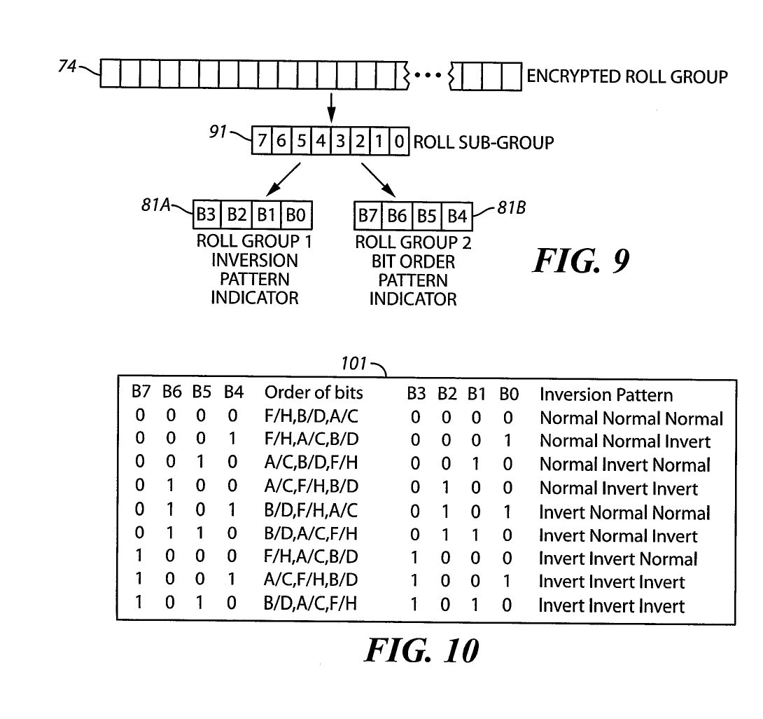

There are various ways by which these recovery identifier values can be selected. Referring momentarily to FIG. 9, by one approach, eight bits from the encrypted roll group 74 are selected to form a corresponding roll sub-group 91. These might comprise, for example, the first or the last eight bits of the encrypted roll group 74 (in a forward or reversed order). These might also comprise, for example, any eight consecutive bits beginning with any pre-selected bit position (such as, to illustrate, the seventh bit, the 21.sup.st bit, and so forth). Other possibilities also exist. For example, only even position bits or odd position bits could serve in this regard. It would also be possible, for example, to use preselected bits as comprise one or more of the previously described roll group sub-groups such as roll group E 74A or roll group G 74C.

It would also be possible to vary the selection mechanism from, for example, joint message to joint message. By one simple approach in this regard, for example, the first eight bits of the encrypted roll group 74 could be used to form the roll sub-group 91 with the last eight bits of the encrypted roll group 74 being used in a similar fashion in an alternating manner.

The eight bits that comprise this roll sub-group 91 are then further parsed to form the two recovery indicators 81A and 81B mentioned above. Again, there are numerous ways by which one may use the bits that comprise the roll sub-group 91 to form these recovery indicators 81A and 81B. By one simple approach, for example, the bits as comprise the roll sub-group 91 can be used in their existing (or reversed) order to form roll group 1 (which serves as a first recovery indicator 81A) and roll group 2 (which serves as a second recovery identifier 81B). Using this approach, for example, bit B3 of roll group 1 would comprise bit seven from the roll sub-group 91 with bit B2 then corresponding to bit six and so forth.

By another approach, if desired, every other bit can be applied in this manner. So configured, for example, bit B3 could comprise bit six from the roll sub-group 91, bit B2 could comprise bit four from the roll sub-group 91, and so forth. In such a case, bit B7 would then comprise bit seven from the roll sub-group 91, bit B6 would comprise bit five from the roll sub-group 91, and so forth.

Referring again to FIG. 8, in this embodiment, the “B7, B6, B5, B4” values from the corresponding recovery indicator are used in conjunction with one or more lookup tables to determine a data bit order pattern to use with respect to formatting the data as comprises the second portion 82 of the joint message 80. Similarly, the “B3, B2, B1, B0” values are used in conjunction with a lookup table to determine a data inversion pattern to also use with that second portion 82 of the joint message 80.

Before providing further elaboration regarding an illustrative example of such lookup tables and their use, it will be helpful to first note that, in this example, the data in the second portion 82 of the joint message comprises 2 pad bits (generally comprising “00,” though any bit pair is possible), 10 bits from roll group F (or H), and 10 bits each from fixed group A (or C) and fixed group B (or D) for a total of 32 bits. These bits (excluding the pad bits) are organized into triplets (shown in FIG. 8 in the form “(F, B, A)” and “(H, D, C)” to indicate that each such triplet includes one bit from a roll group F or H and one bit each from the two fixed groups B and A or D and C. Those skilled in the art will recognize that the pad bits may reside at any position in the second portion 82 of the joint message, and may reside together or separately. Those skilled in the art will also recognize that the pad bits are optional, and are provided in this illustrative example merely to create a joint message 80 with a total bit count factor of 8 bits (1 byte) to allow for transmission with many wireline (and wireless) methods and protocols readily known in the art.

Those skilled in the art will note that, in this illustrative example, bits from roll group E 74A and roll group G 74C are not present in the second portion 82 of the joint message 80. This is because, in this example, it is presumed that the contents of these two roll groups are used to form the recovery indicators that appear in the first portion 81 of the joint message 80. Other accommodations can of course be made in this regard. In general, however, these teachings will accommodate not including those encrypted rolling code bits that are used as recovery indicators in the second portion 82 of the joint message 80.

In the example shown, the order of the bits in each triplet is “F, B, A” (or “H, D, C” as appropriate). This order is neither arbitrary nor static. Instead, for this particular joint message 80, this order of the bits in each triplet is dictated by the values B7, B6, B5, B4 noted above. In this case, and referring now to FIG. 10, an example lookup table 101 serves to correlate various values for these two bit pairs with corresponding data bit order patterns. In this example, presuming that the values of these four bits happens to be “0000,” the corresponding order of bits for each triplet is established as “F/H, B/D, A/C” and hence the ordering of the bits depicted in FIG. 8.

Those skilled in the art will note that this lookup table 101 provides no patterns that would correlate to two bit pairs having the value “11.” This is because, in this embodiment, “11” as a bit pair value comprises an illegal value and hence is not expected to occur. Accordingly there are no bit order patterns presented to correlate with such values as “11XX,” “XX11,” or “1111.” This creates 9 possible selections for the order of bits and the inversion value. The number of possible unique order of three bits leads to only six different bit order patterns. This degree of diversity should suffice for most if not all purposes.

The aforementioned B3, B2, B1, B0 values are employed in a similar fashion with this lookup table 101 to identify a particular inversion pattern to be employed with the data triplets of the second portion 82 of the joint message 80. For example, when these bits are “0000,” this lookup table provides for no inversion of any of the bits in each triplet. On the other hand, when these bits are “1010,” each bit of each triplet is to be inverted. In this case, up to eight different inversion patterns are possible.

To illustrate further, when a given data triplet happens to have the values “110” and the inversion indicator has the values “0100,” the lookup table will return a data inversion pattern of “normal invert invert.” As a result, this particular data triplet will instead have the values “101” because the second and third values in each triplet are now to be inverted in value.

One skilled in the art will note that the example lookup table 101 shown in FIG. 10 is but one of many possible lookup tables 101. Numerous different permutations of similar tables may be created and utilized, each having different assignments of varying (or repeating) inversion patterns and order patterns assigned to different roll group patterns. In some examples, a system can be implemented using multiple lookup tables having different inversion and order patterns assigned to different roll group patterns.

So configured, a first portion of a joint message is seen to include a recovery indicator that itself comprises a selected portion of an encrypted rolling code. A second portion of that joint message, in turn, contains data triplets having bits that are arranged in a particular order and that observe a particular inversion pattern as a function of that joint indicator. Accordingly, it will not be sufficient for an unauthorized party to simply glean, in some fashion, the basis of the rolling code itself. Instead, now, this unauthorized party must also now understand how a particular portion of that rolling code is used to modify the transmission of other portions of that rolling code in addition to fixed information as may also accompany the rolling code.

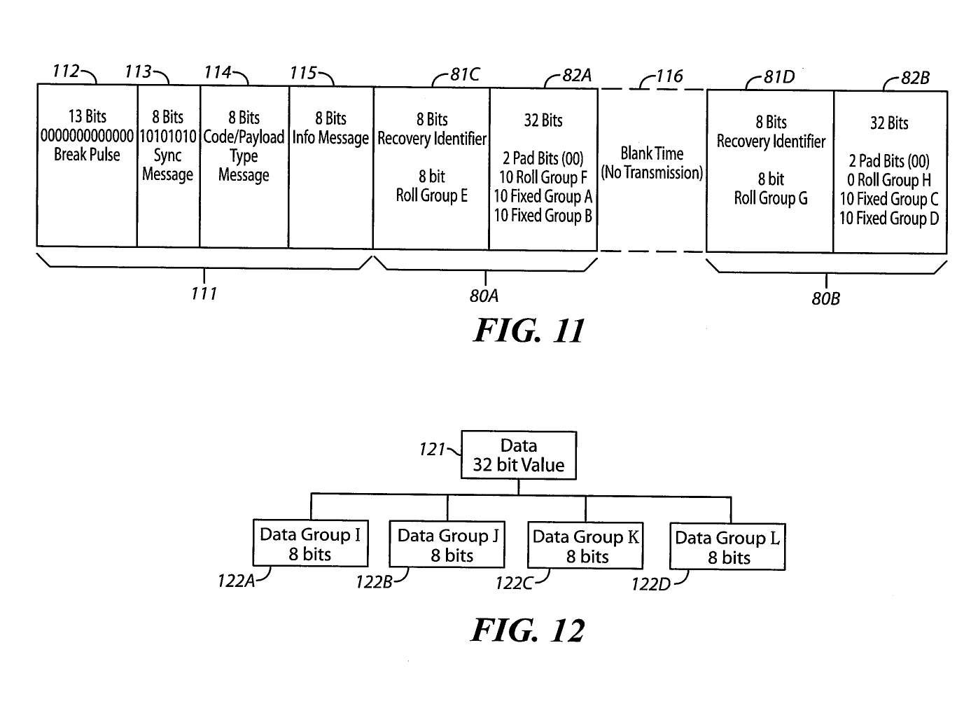

Referring now to FIG. 11, by one example, transmission of a joint message 80 may include message header information 111. The message header information 111 may further comprise, by one example, a break pulse 112, a sync message 113, a code/payload type message 114, and an info message 115. The break pulse 112 generally consists of a 13 bit string of 0, but other break pulses 112 of differing lengths and contents may exist. In certain instances, for example, where a transmission wireline is utilized by devices for both power and data, it may be beneficial to limit the time length of the break pulse 112 to a maximum of 20 milliseconds to prevent brownout situations. Following the break pulse 112, a sync message 113 may be transmitted. This sync message 113 may comprise a simple 8 bit pattern (for example, “10101010” (0x55)) to enable automatic baud rate detection in a receiving device. Other bit patterns and lengths may be utilized to effectuate syncing between transmitting and receiving devices.

Following the sync message 113, a code/payload type message 114 may be transmitted comprising bit patterns indicating a code type (for example, which lookup table 101 of a possible plurality of look-up tables should be utilized) and a payload type. For example, the four most-significant bits of the code/payload type message 114 may be utilized to specify the code type (for example, “0000” may specify one look-up table 101, “0001” may specify another different look-up table 101, and so forth). The bit pattern indicating payload type may indicate that the joint message 80 is of a type that includes a fixed content (described above), of a type that includes non-fixed content or a data payload, or of a type that includes both a fixed content and non-fixed content or a data payload. In this same example, the four least-significant bits of the code/payload type message may be utilized to specify the payload type (for example, “0000” may specify that the joint message 80 is of a type that includes a fixed content and “0001” may specify that the joint message 80 is of a type that includes non-fixed content or a data payload).

Lastly, the message header information 111 may include an info message 115 that can be utilized for any number of different purposes, including but not limited to indication of the data frame number in a series of data frames, information overflow from a data payload, and so forth. Further, by including the info message 115 in the message header information 111, the present teachings are well suited to accommodate future capability expansion without altering established system messaging architectures.

In many application settings it may be desirable to present more than one joint message 80 to present a complete transmission. For example, and referring again to FIG. 11, it may be desirable to use two (or more) such joint messages 80A and 80B in order to present the complete rolling code and the complete fixed content and was described above. In such a case, for example, the first joint message 80A can present and use a first roll sub-group 91 as defined above as a recovery identifier (which comprises, in this illustrative example, roll group E 74A) while the second joint message 80B presents and uses a second, different roll sub-group B 91 (which comprises, in this illustrative example, roll group G 74C) for this purpose. These recovery identifiers can be used as just described to control modification of their corresponding data. So configured, in this illustrative example, 10 bits of roll group F 74B, 10 bits of fixed group A 75A, and 10 bits of fixed group B 75B have their bits ordered and inverted as a function of the bits of roll group E 74A and reside in the second part 82A of the first joint message 80A while 10 bits of roll group H 74D, 10 bits of fixed group C 75C, and 10 bits of fixed group D 75D are similarly ordered/inverted as a function of the bits of roll group G 74C and reside in the second part 82B of the second joint message 80B. Each second part 82A and 82B of the joint messages 80A and 80B may also contain pad bits, as described above, thereby creating second parts 82A and 82B of the joint message 80A and 80B having total bit lengths of 32 bits (4 bytes).

If desired, these joint messages 80A and 80B can be sent in a concatenated manner, thereby potentially maximizing network throughput. By an optional approach, however, these joint messages 80A and 80B can be separated by at least a minimal blank time 116 (achieved, for example, by not transmitting during this period of time). For example, 75 milliseconds or so of blank time can be used for this purpose. So configured, a receiver that receives a second joint message prior to this period of blank time expiring can conclude that one or both of the received messages is somehow in error and should be avoided.

As noted above, in some cases it may be useful to transmit an additional amount of data or information than that specifically provided above. For example, it may be useful to transmit additional data that represents a particular instruction, status information, or the like. Such additional information can be readily accommodated by the teachings set forth above. To illustrate, and referring now to FIG. 12, 32 bits of such additional data 121 can be subdivided into four corresponding data groups I and J 122A and 122B and K and L 122C and 122D where each such data group has eight bits.

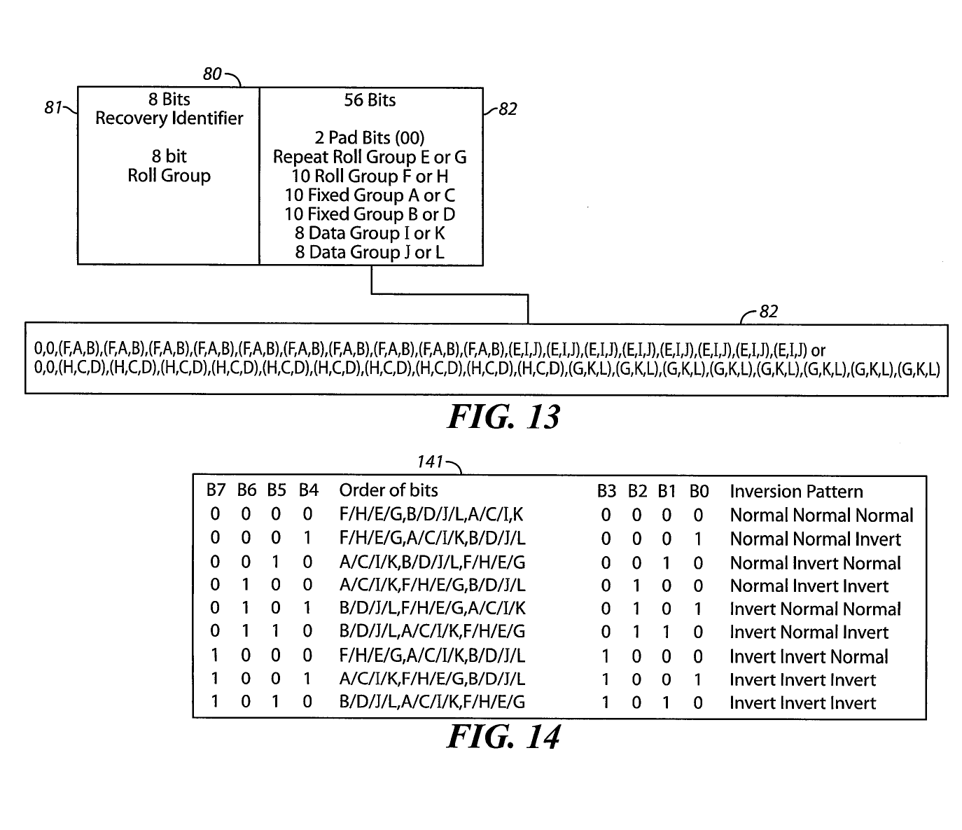

Referring now to FIG. 13, the second portion 82 of each joint message 80 can now comprise 56 bits. By one approach, this can comprise 2 pad bits (as described above), 8 bits for a repeated presentation of the same rolling code group E or G as comprises the recovery identifier, 10 bits each for rolling code group F or H, fixed group A or C, and fixed group B or D, as well as 8 bits each for data group I or K and data group J or L as are described above. These various bits are again combined into data triplets using a group selection pattern such as that illustrated in FIG. 13. And, once again, the recovery identifier comprised of the roll group presented in the first portion 81 of the joint message 80 is used to select from a lookup table(s) the particular bit order and inversion patterns to employ with respect to these data triplets. In this case, and referring now to FIG. 14, the lookup table 141 can include specific bit order patterns that apply in different ways depending upon whether the data triplet includes the supplemental data. This joint message 80 can optionally be transmitted with appropriate message header information 111 and optionally concatenated with at least one other joint message 80 (similar to the message transmission format described in FIG. 11).

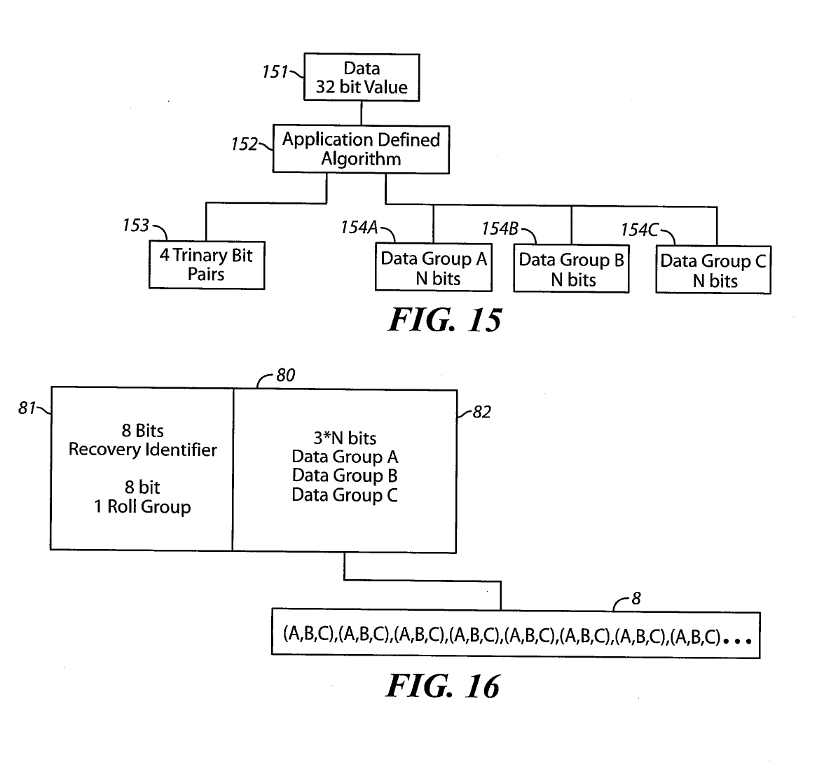

In some cases, it may be necessary or appropriate to transmit even a larger quantity of data than can be accommodated by the processes and techniques described above. In such a case, if desired, additional supplemental joint messages can be used to present such supplemental data. With reference to FIG. 15, 32 bit value data elements 151 can be parsed using an application defined algorithm 152 of choice as corresponds to the data itself (or as may be otherwise provided or selected) into four ternary bit pairs 153 and three data groups of N bits each 154A-154C.

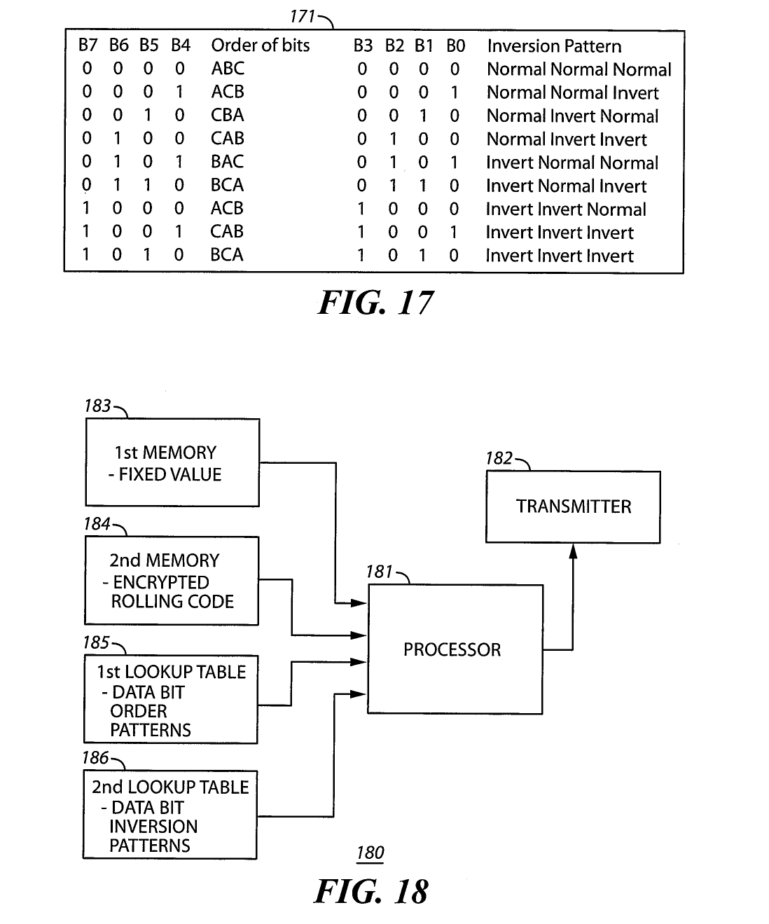

Referring now to FIG. 16, the recovery indicator can be reused from a previous related joint message and the second portion 82 of the joint message 80 can contain 3 to the Nth power bits as necessary to accommodate the full data payload. The three data groups A-C are then used to form corresponding data triplets. And, as before, the recovery identifier is used to extract from a corresponding lookup table (such as the lookup table 171 presented in FIG. 17) the particular bit order pattern and bit inversion pattern to employ with respect to the transmission of these data triplets.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 18, an illustrative approach to such a platform will now be provided.

In this illustrative embodiment, the apparatus 180 (which may comprise, for example, a wireline control unit immovably or semi-movably affixed to a surface of a fixed-in-place structure, such as a wall control unit) comprises a processor 181 that couples to a transmitter 182 (such as a wireline transmitter) of choice. Both of these components then also operably couple to a first memory 183, a second memory 184, a first lookup table 185, and a second lookup table 186. The first memory 183 can have a fixed value stored therein. This fixed value can comprise, for example, information that substantially uniquely identifies this particular apparatus 180. This first memory 183 may also, if desired, have a plurality of different fixed values contained therein. This would permit storing, for example, remote control signals that are not specific (i.e., unique) to the apparatus 180 itself.

The second memory 184 can have the aforementioned encrypted rolling code stored therein. By one approach, the processor 181 is configured and arranged to calculate the encrypted rolling code when needed and to temporarily buffer that value in the second memory 184 pending actual use of that information. By another approach, the encrypted rolling code information can be pre-provisioned using a derivation and storage approach of choice.

The lookup tables 185 and 186 are the lookup tables described above. For example, the first lookup table 185 can comprise the lookup table that correlates a first plurality of different encrypted rolling code values with corresponding differing data bit order patterns. Similarly, the second lookup table 186 can comprise the lookup table that correlates a second plurality of different encrypted rolling code values with corresponding different data inversion patterns.

The processor 181 itself is configured and arranged (via, for example, appropriate programming) to carry out selected teachings as have been presented above. So configured, for example, the processor 181 can be configured and arranged to use the encrypted rolling code to select ones of the particular data bit order patterns and data inversion patterns for the transmitter 182 to use as transmission characteristics when transmitting the fixed value and at least portions of the encrypted rolling code. In particular, if desired, the processor can use a first part of the encrypted rolling code to select a data bit order pattern and a data inversion pattern to use when transmitting a first part of the encrypted rolling code and the fixed value and a second, different part of the encrypted rolling code to select a data bit order pattern and a data inversion pattern to use when transmitting a second, different part of the encrypted rolling code and the fixed value.

Those skilled in the art will recognize and understand that such an apparatus 180 may be comprised of a plurality of physically distinct elements as is suggested by the illustration shown in FIG. 18. It is also possible, however, to view this illustration as comprising a logical view, in which case one or more of these elements can be enabled and realized via a shared platform and/or a more-widely-distributed platform. It will also be understood that such a shared platform may comprise a wholly or at least partially programmable platform as are known in the art.

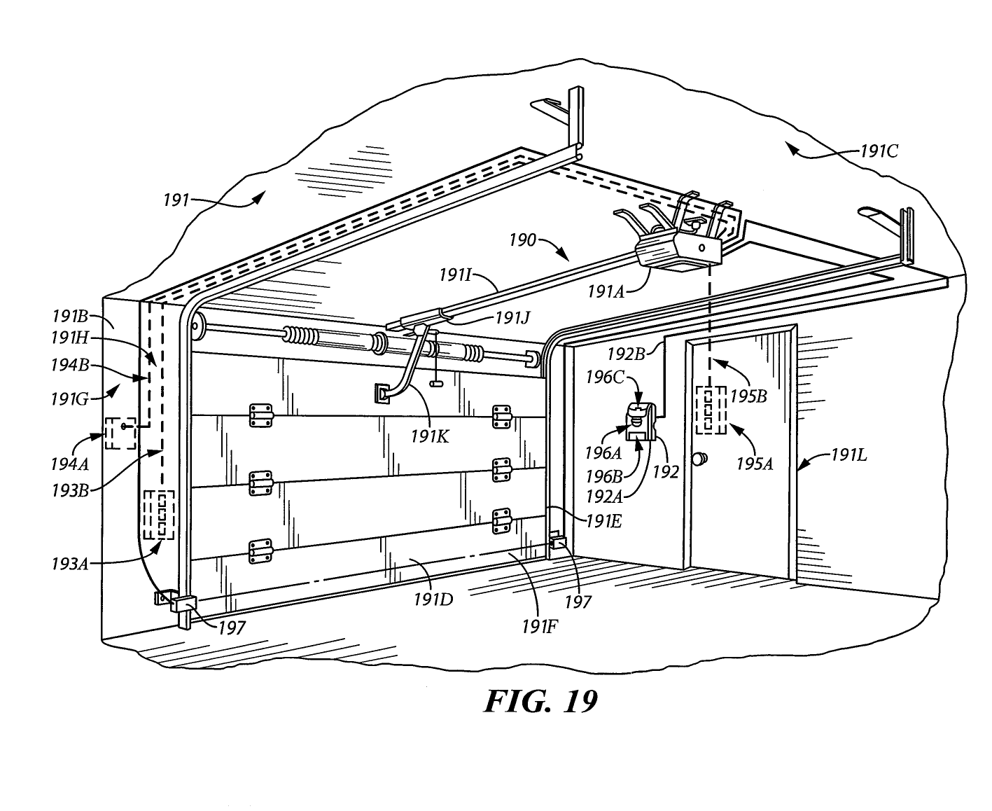

Referring now to FIG. 19, it may be helpful to describe an illustrative application setting. It will be understood that the specifics of this example are intended to serve only in an illustrative regard and are not intended to express or suggest any corresponding limitations with respect to the scope of these teachings.

In this illustrative example, a barrier movement controller 190 comprises, in part, various garage and garage door elements 191, such as a garage door operator 191A positioned within a garage 191B. This garage door operator 191A mounts to the garage ceiling 191C and serves to control and effect selective movement of a multipanel garage door 191D. The multipanel garage door 191D includes a plurality of rollers (not shown) rotatably confined within a pair of tracks 191E positioned adjacent to and on opposite sides of the garage opening 191F. The garage 191B also has internal 191G and external wall surfaces 191H. The garage 191B may also have one or more utility doors 191L (it being understood that a “utility door” serves to provide a human being of at least average height, weight, and physical ability with a selectively closeable and openable pathway by which this person can personally exit the garage and/or gain entry to the garage other than via the aforementioned garage door).

The garage door operator 191A includes a head unit have a motor (not shown) to provide motion to the garage door 191D via a rail assembly 191I. The rail assembly 191I includes a trolley 191J for releasable connection of the head unit to the garage door 191D via an arm 191K. The arm 191K connects to an upper portion of the garage door 191D. The trolley 191J connects to an endless chain (or belt or the like) (not shown) that effects the desired movement of the trolley 191J and hence the door 191D via the arm 191K. This chain can be driven by a sprocket (not shown) that couples to the aforementioned motor in the head unit.

The barrier movement controller 190 may include at least one apparatus 180 comprising a wireline control unit 192 immovably or semi-movably affixed, when properly installed as per the intentions and instructions of the manufacturer, to a surface of the garage 191B, such as the garage ceiling 191C, internal wall surfaces 191G, or external wall surfaces 191H, or to any of the various garage and garage door elements 191. The wireline control unit 192 is operably connected to the garage door operator 191A via a wireline 192B (as used herein, this reference to “wireline” will be understood to refer to one or more solid electrical conductors (including both single wire and multiple wire configurations, solid light-bearing carriers (such as optical fibers), and so forth).

By way of a particular example, the wireline control unit 192 may comprise a wall control unit 192A affixed to an internal wall surface 191G of the garage 191B (preferably, but not necessarily, near a utility door 191L possibly leading to a main building attached to the garage 191B or to the exterior of the garage 191B). Optionally, in lieu of or in addition to the aforementioned wall control unit 192A, another wall control unit 193A may be affixed to an interior wall surface 191G located near the garage door 191D, which is also connected via another wireline 193B to the garage door operator 191A. Additionally, in lieu of or in addition to the aforementioned wall control units 192A, 193A, yet another wireline control unit 194A may be affixed to an exterior wall surface 191H located near the garage door 191D and operably connected to the garage door operator via yet another wireline 194B. Optionally, a vertically-suspended wireline control unit 195A may be connected to the garage door operator 191A by yet another wireline 195B and suspended from the ceiling 191C, the garage door operator 191A, or any other garage and garage door element 191 by a supportive material such as a rope, a chain, or the wireline 195B itself.

The wireline control unit 192 may comprise a housing made of plastic, metal, or other suitable materials, and one or more buttons or switches 196A operably associated with one or more functions of the barrier movement controller 190 and that are readily accessible to an end user seeking to physically interact with such buttons/switches. These buttons 196A may comprise any variety of button types, including mechanical and electrical buttons as are known in the art. Alternatively, these buttons may be embodied on a touch screen. These buttons 196A may, for example, comprise a single toggle button to effectuate opening and closing of the garage door 191D, or to stop the garage door operator 191A during operation. Alternatively, various barrier movement controller 191A functions can be assigned to multiple buttons (for example, one button for “UP,” one button for “DOWN,” and one button for “STOP”). Alternatively, the buttons 196A may comprise a keypad a user employs to input codes to effectuate functions of the barrier movement controller 190.

By yet another approach, the wireline control unit 192 may comprise, in lieu of or in addition to the aforementioned buttons 196A, one or more alternate mechanisms for user interaction with the wireline control unit 196B (such as a biometric scanner (including fingerprint and retinal scanners), a radio frequency identifier (RFID) reader, or a voice recognition module). In addition to controlling movement of the garage door 191D, other functions of the barrier movement controller 190 may be assigned to any of the one or more buttons 196A or alternate mechanisms for user interaction 196B (resulting in, for example, a light toggle button, a lockout button, a programming button, and so forth).

In various embodiments, the wireline control unit 192 may include a display 196C that may or may not be illuminated. This display 196C may also contain the aforementioned touch-screen capabilities. The wireline control unit 192 may be powered by any methods of choice known in the art, including external or internal power supplies, battery, solar power, or even power derived from the garage door operator 191A through the wireline 192B, 193B, 194B, 195B.

The head unit may also include a radio frequency receiver (not shown) having an antenna (not shown) to facilitate receiving coded radio frequency transmissions from one or more wireless radio transmitters (not shown). These wireless transmitters may include portable wireless transmitters (such as keyfob-style transmitters) or wireless keypad transmitters (such as those often installed in automobile sun visors). The radio receiver typically connects to a processor (181) in the head unit that interprets received signals and responsively controls other portions of the garage door operator 191A.

In addition, in this illustrative example the barrier movement controller 191A includes an obstacle detector 197 that optically or via an infrared-pulsed beam detects when the garage door opening is blocked and signals the garage door operator 191A accordingly of the blockage. The aforementioned processor can then, for example, cause a reversal or opening of the door 191D to avoid contact with the obstacle.

So configured, those skilled in the art will recognize and appreciate that these teachings offer great flexibility and opportunity with respect to further protecting information during a wireline transmission of that information. These teachings have particular relevance to transmissions of rolling codes and offer particular advantages when also used in conjunction with the transmission of fixed information in addition to rolling code information. The particular transmission characteristics presented are largely compatible for use with a wide variety of wireline modulation techniques, mediums, methods, and protcols. Those skilled in the art will also appreciate that these teachings are highly compatible for use with binary-based representations of ternary data formats.

So configured, a given movable barrier operator, using a single protocol, can successfully communicate with both wireless and wireline-based user interfaces. These teachings will readily support using fixed codes and/or rolling codes to permit the movable barrier operator to readily identify and distinguish these various user interfaces from one another. These teachings are highly scalable and can be employed in conjunction with a wide variety of movable barrier operators and/or application settings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing an encrypted rolling code;
providing a plurality of differing data bit order patterns;
providing a plurality of differing data inversion patterns;
selecting a particular one of each of the data bit order patterns and the data inversion patterns to provide selected patterns;
transmitting via wireline at least a part of the encrypted rolling code using the selected patterns as transmission characteristics.

2. The method of claim 1 wherein the encrypted rolling code comprises a plurality of bit pairs.

3. The method of claim 1 wherein the differing data bit order patterns each comprise a pattern for exactly three bits.

4. The method of claim 1 wherein the differing data inversion patterns each comprise a pattern for exactly three bits.

5. The method of claim 1 wherein:
providing a plurality of differing data bit order patterns comprises providing at least six different bit order patterns; and
providing a plurality of differing data inversion patterns comprises providing at least eight different data inversion patterns.

6. The method of claim 1 wherein selecting a particular one of each of the data bit order patterns and the data inversion patterns to provide selected patterns comprises using the rolling code to select the particular data bit order pattern and data inversion pattern to provide the selected patterns.

7. The method of claim 6 wherein using the encrypted rolling code to select the particular data bit order pattern and data inversion pattern to provide the selected patterns comprises using a predetermined portion of the encrypted rolling code to select the particular data bit order pattern and data inversion pattern to provide the selected patterns.

8. The method of claim 7 wherein using a predetermined portion of the encrypted rolling code to select the particular data bit order pattern and data inversion pattern to provide the selected patterns comprises using a predetermined four bit pairs of the encrypted rolling code to select the particular data bit order pattern and data inversion pattern to provide the selected patterns.

9. The method of claim 7 wherein using a predetermined portion of the encrypted rolling code to select the particular data bit order pattern and data inversion pattern to provide the selected patterns further comprises:
using a first predetermined portion of the encrypted rolling code to select a first particular data bit order pattern and a first data inversion pattern to provide first selected patterns; and
using a second predetermined portion of the encrypted rolling code to select a second particular data bit order pattern and a second data inversion pattern to provide second selected patterns;
wherein the first and second predetermined portions of the encrypted rolling code are discrete from one another.

10. The method of claim 1 further comprising:
providing a fixed code;
and wherein transmitting via wireline at least a part of the encrypted rolling code using the selected patterns as transmission characteristics further comprises transmitting via wireline at least a part of the encrypted rolling code and the fixed code using the selected patterns as transmission characteristics.

11. A method to facilitate transmitting a wireline remote control message comprising:
providing a fixed message having at least a first and second part;
providing an encrypted rolling code having at least a first, second, third, and fourth part;
providing a plurality of differing data bit order patterns;
providing a plurality of differing data inversion patterns;
using the first part of the encrypted rolling code to select a particular one of each of the data bit order patterns and the data inversion patterns to provide first selected patterns;
using the second part of the encrypted rolling code to select a particular one of each of the data bit order patterns and the data inversion patterns to provide second selected patterns;
transmitting via wireline:
the first part of the fixed message and the third part of the encrypted rolling
code using the first selected patterns as transmission characteristics;
the second part of the fixed message and the fourth part of the encrypted
rolling code using the second selected patterns as transmission characteristics.

12. The method of claim 11 wherein transmitting via wireline further comprises:
transmitting via wireline the first and second parts of the encrypted rolling code without using either the first or second selected patterns as transmission characteristics to thereby provide recovery identifiers to be used when recovering at a receiver the first and second parts of the fixed message and the third and fourth parts of the encrypted rolling code.

13. The method of claim 12 wherein the first and second parts of the encrypted rolling code each comprise four bit pairs.

14. The method of claim 13 wherein
using the first part of the encrypted rolling code to select a particular one of each of the data bit order patterns and the data inversion patterns to provide first selected patterns comprises using two bit pairs of the four bit pairs as comprise the first part of the encrypted rolling code and a first lookup table to correlate the two bit pairs to a corresponding data bit order pattern and using a different two bit pairs of the four bit pairs as comprise the first part of the encrypted rolling code and a second lookup table to correlate the different two bit pairs to a corresponding data inversion pattern;
using the second part of the encrypted rolling code to select a particular one of each of the data bit order patterns and the data inversion patterns to provide second selected patterns comprises using two bit pairs of the four bit pairs as comprise the second part of the encrypted rolling code and the first lookup table to correlate the two bit pairs to a corresponding data bit order pattern and using a different two bit pairs of the four bit pairs as comprise the second part of the encrypted rolling code and the second lookup table to correlate the different two bit pairs to a corresponding data inversion pattern.

15. The method of claim 14 wherein transmitting via wireline comprises transmitting via wireline using Manchester encoding.

16. The method of claim 15 wherein transmitting via wireline further comprises:
transmitting via wireline the second part of the fixed message and the fourth part of the encrypted rolling code using the second selected patterns as transmission characteristics only after not transmitting for at least a predetermined period of time following transmission of the first part of the fixed message and the third part of the encrypted rolling code using the first selected patterns as transmission characteristics.

17. The method of claim 16 wherein the predetermined period of time comprises about 75 milliseconds.

18. The method of claim 11 wherein the fixed message comprises a value that is substantially unique to a given wireline transmitter and therefore serves to identify the given wireline transmitter.

19. The method of claim 18 further comprising:
providing a data payload that is not substantially unique to the given wireline transmitter; and wherein transmitting via wireline:
the first part of the fixed message and the third part of the encrypted rolling code using the first selected patterns as transmission characteristics;
the second part of the fixed message and the fourth part of the encrypted rolling code using the second selected patterns as transmission characteristics;
further comprises:
transmitting:
the first part of the fixed message, the third part of the encrypted rolling code, and a first part of the data payload using the first selected patterns as transmission characteristics;
the second part of the fixed message, the fourth part of the encrypted rolling code, and a second part of the data payload using the second selected patterns as transmission characteristics.

20. The method of claim 19 wherein the data payload comprises a movable barrier operator wireline remote control signal.

21. The method of claim 20 wherein transmitting via wireline further comprises transmitting via wireline a remaining part of the data payload using one of the selected patterns as transmission characteristics.

22. An apparatus comprising:
a first memory having a fixed value stored therein;
a second memory having an encrypted rolling code stored therein;
a first lookup table that correlates a first plurality of different encrypted rolling code values with corresponding differing data bit order patterns;
a second lookup table that correlates a second plurality of different encrypted rolling code values with corresponding differing data inversion patterns;
a processor that is operably coupled to the first and second memory and the first and second lookup table and that is configured and arranged to use the encrypted rolling code to select ones of the particular data bit order patterns and data inversion patterns to provide selected patterns;
a wireline transmitter operably coupled to the first and second memory and to the processor and being configured and arranged to transmit via wireline at least a part of the encrypted rolling code and the fixed value using the selected patterns as transmission characteristics.

23. The apparatus of claim 22 wherein the apparatus comprises a movable barrier operator wireline remote control.

24. The apparatus of claim 22 wherein the processor is further configured and arranged to use:
a first part of the encrypted rolling code to select a data bit order pattern and a data inversion pattern to use when transmitting via wireline a first part of the encrypted rolling code and the fixed value; and
a second, different part of the encrypted rolling code to select a data bit order pattern and a data inversion pattern to use when transmitting via wireline a second, different part of the encrypted rolling code and the fixed value.

25. The apparatus of claim 22 wherein the fixed value comprises at least one of:
a substantially unique identifier for the apparatus;
a wireline remote control signal that is not specific to the apparatus.

26. The apparatus of claim 25 wherein the fixed value comprises both of the substantially unique identifier for the apparatus and the wireline remote control signal that is not specific to the apparatus.

27. A method comprising:
at a wireline remote control transmitter:
providing data to be transmitted via wireline, wherein the data comprises, at least in part, at least portions of an encrypted rolling code wherein the data comports with a particular data bit order pattern and a particular data inversion pattern as a function of a given portion of the rolling code;
transmitting via wireline the data in combination with the given portion of the encrypted rolling code wherein the given portion of the encrypted rolling code is not transmitted with any of its bits reordered or inverted as a function of the given portion of the encrypted rolling code such that a receiver that receives the data can properly recover the at least portions of the encrypted rolling code as a function of the given portion of the encrypted rolling code.

28. The method of claim 27 further comprising:
storing the data in a memory prior to transmitting the data.

29. The method of claim 27 wherein providing data to be transmitted via wireline comprises providing data to be transmitted via wireline wherein the data comprises, at least in part:
a first data portion comprising a first portion of the encrypted rolling code wherein the first data portion comports with a first data bit order pattern and a first data inversion pattern as a function of a first given portion of the encrypted rolling code;
a second data portion comprising a second, different portion of the encrypted rolling code wherein the second data portion comports with a second data bit order pattern and a second data inversion pattern as a function of a second given portion of the encrypted rolling code.

30. The method of claim 29 wherein transmitting via wireline the data comprises:
transmitting via wireline the first data portion in combination with the first given portion of the encrypted rolling code wherein the first given portion of the encrypted rolling code is not transmitted with any of its bits reordered or inverted as a function of the first given portion of the encrypted rolling code such that a receiver that receives the first data portion can properly recover the first portion of the encrypted rolling code as a function of the first given portion of the encrypted rolling code;
transmitting via wireline the second data portion in combination with the second given portion of the encrypted rolling code wherein the second given portion of the encrypted rolling code is not transmitted with any of its bits reordered or inverted as a function of the second given portion of the encrypted rolling code such that a receiver that receives the second data portion can properly recover the second portion of the encrypted rolling code as a function of the second given portion of the encrypted rolling code.

31. The method of claim 30 wherein transmitting via wireline further comprises not transmitting for a predetermined period of time in between transmitting the first data portion and the second data portion.

32. The method of claim 31 wherein the predetermined period of time comprises about 75 milliseconds.

33. A method comprising:
at a wireline transmitter:
providing a message comprised of binary bit pairs and comprising at least three portions, wherein:
a first portion intentionally comprises an illegal binary bit pair;
a second portion that substantially uniquely identifies the wireline transmitter;
a third portion that identifies, at least in part, how to recover the second portion.

34. The method of claim 33 wherein the first portion comprises at least one legal binary bit pair intentionally followed by the illegal binary bit pair.

35. The method of claim 34 wherein the illegal binary bit pair substantially immediately follows the legal binary bit pair.

36. The method of claim 35 wherein the third portion identifies, at least in part, how to adjust a data order pattern and a bit inversion pattern for bits as comprise the second portion.

37. A method for use with a wireline receiver that is configured and arranged to compatibly receive and process a wireline-transmitted encrypted rolling code, wherein:
the wireline-transmitted encrypted rolling code comprises at least a part thereof that was transmitted via wireline using selected patterns of transmission characteristics, wherein a first one of the selected patterns comprises a selected particular one of a plurality of differing data bit order patterns and wherein a second one of the selected patterns comprises a selected particular one of a plurality of differing data inversion patterns;
the method comprising:
at a wireline transmitter:
providing a message that will be compatibly received and processed by the wireline receiver as the wireline-transmitted encrypted rolling code;
transmitting via wireline the message to the wireline receiver.

38. The method of claim 37 wherein providing a message comprises providing a message that comprises, at least in part, a representation of the selected patterns of transmission characteristics.

39. The method of claim 37 wherein transmitting via wireline the message to the wireline receiver comprises a wireline wall control unit transmitting via wireline the message to the wireline receiver.
